(19) United States
(12) Patent Application Publication
(10) Pub. No.: US 2007/0080783 A1
(43) Pub. Date: Apr. 12, 2007

(54) System and method for controlling performance of a RFID network

(76) Inventors: Arunabha Ghosh, Austin, TX (US); Anil Doradla, Austin, TX (US)

Correspondence Address: BRINKS HOFER GILSON & LIONE, P.O. BOX 10395, CHICAGO, IL, 60610, US

(21) Appl. No.: 11/248,761

(22) Filed: Oct. 11, 2005

(51) Int. Cl. H04Q 5/22; H04J 3/08

(52) U.S. Cl. 340/10.1; 370/315

(57) ABSTRACT

A system and method for controlling the performance of a RFID network comprising a plurality of RFID tags and a central unit is disclosed. Each of the plurality of RFID tags is operative to transmit a data packet comprising a unique identification for that RFID tag. Additionally, each RFID tag is operative to receive a data packet from another RFID tag of the plurality of RFID tags, make a random determination based on a probability whether to re-transmit the data packet, and re-transmit the received data packet dependent on the random determination. The central unit in communication with the plurality of RFID tags is operative to receive the data packets from the plurality of RFID tags.

### BACKGROUND

Radio frequency identification (“RFID”) tags have gained popularity in a broad range of industries. For example, in automated inventory management, RFID tags are used to uniquely identify products and easily enter data associated with the uniquely identified product into electronic mediums. Traditionally, during operation a RFID sensor (or reader) is brought within the proximity of a RFID tag attached to a product. The RFID tag either periodically, or in response to a trigger signal from the RFID sensor, transmits a unique data packet to the RFID sensor. In response to receiving the unique data packet, the RFID sensor identifies the unique RFID tag and enters data associated with the unique RFID tag into an electronic medium for processing.

In a large warehouse consisting of several thousand items with RFID tags, it is important to accurately account for each RFID tag attached to an item. Traditional methods of passing a RFID sensor in close proximity to a RFID tag consumes large amounts of time and effort, and is prone to errors. To address this problem, RFID mesh networks have been created to allow each RFID tag to sense the presence of other RFID tags within the proximity of the RFID tag and relay information from the other RFID tags within the proximity of the RFID tag. However, these RFID mesh networks encounter problems due to each RFID tag attempting to relay multiple copies of one data packet, thereby creating an overflow of information and collisions of multiple data packets arriving at one RFID tag at one time.

### BRIEF DESCRIPTION OF THE DRAWINGS

FIG. 1 is a diagram of a RFID mesh network according to one embodiment of the present disclosure;

FIG. 2 is a diagram of one embodiment of a RIFD tag;

FIG. 3 is a diagram of a first iteration of re-transmission of a data packet according to one embodiment of the present disclosure;

FIG. 4 is a diagram of a second iteration of re-transmission of the data packet of FIG. 3;

FIG. 5 is a diagram of a third iteration of re-transmission of the data packet of FIG. 3;

FIG. 6 is a flow chart for the operation of one embodiment of a RFID tag during one iteration of re-transmission of a data packet;

FIG. 7 is a flow chart for the operation of one embodiment of a central unit;

FIG. 8 is an illustrative embodiment of a general computer according to one embodiment of the present disclosure;

FIG. 9 is a graph illustrating transmission range during successive iterations of re-transmission of a data packet and an area associated with each transmission range;

FIG. 10 is a graph illustrating the number of surviving data packets after iterations of re-transmission for three different models of data packet collision where the probability a RFID tag will re-transmit a received data packet is 0.27;

FIG. 11 is a graph illustrating the number of surviving data packets after iterations of re-transmission for three different models of data packet collision where the probability a RFID tag will re-transmit a received data packet is 0.23; and

FIG. 12 is a graph illustrating the number of surviving data packets after iterations of re-transmission for three different models of data packet collision where the probability a RFID tag will re-transmit a received data packet is 0.25.

### DETAILED DESCRIPTION OF THE DRAWINGS

The present disclosure is directed to a system and method for controlling the performance of a RFID mesh network comprising a plurality of RFID tags and a central unit. To increase efficiency, each RFID tag in the RFID mesh network is operative to transmit a unique data packet from the RFID tag, and to receive and re-transmit a unique data packet transmitted from other RFID tags until the central unit receives at least one copy of each of the unique data packets. In order to alleviate congestion within the RFID mesh network due to multiple copies of each data packet, each RFID tag makes a random decision whether to re-transmit any unique data packet received from another RFID tag.

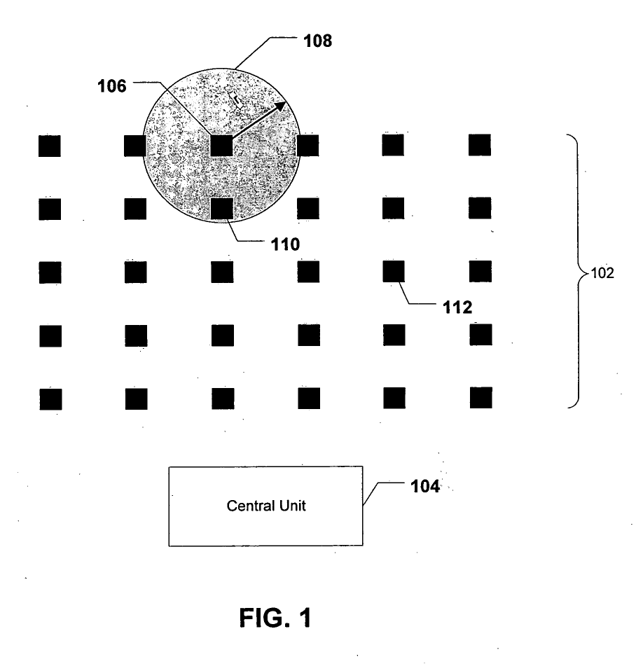

FIG. 1 is a diagram of one embodiment of a RFID mesh network 100. The RFID mesh network 100 typically comprises a plurality of RFID tags 102, wherein each of the RFID tags is in communication with at least one other RFID tag of the plurality of RFID tags 102, and a central unit 104 in communication with at least one of the plurality of RFID tags 102.

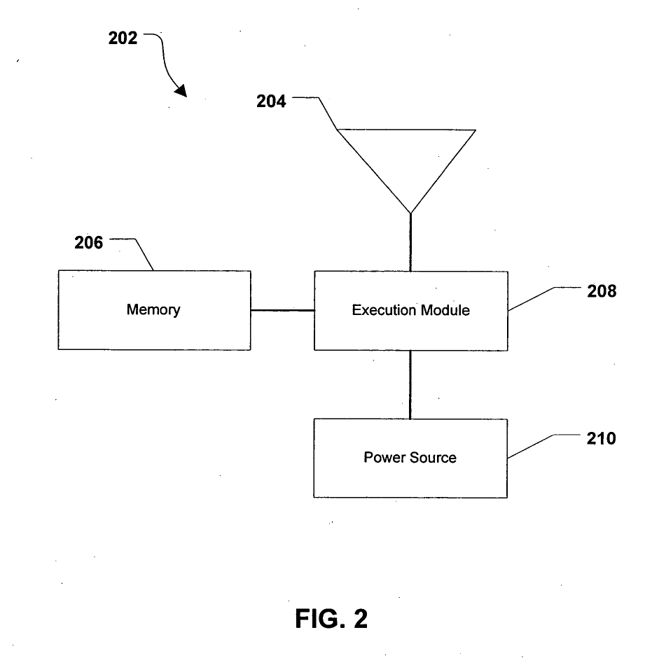

FIG. 2 is a diagram of one embodiment of an RFID tag 202. Typically, each RFID tag 202 may be a passive or active radio device, as is known in the art, comprising an antenna 204 to receive and transmit data packets, a memory 206 to store at least a set of logic, and an execution module 208 operative to execute at least the set of logic stored in the memory 206.

Each RFID tag 202 of the plurality of RFID tags 102 (FIG. 1) is operative to transmit a unique data packet which at least identifies the particular RFID tag 202. Additionally, each RFID tag 202 is operative to receive unique data packets transmitted from other RFID tags, and determine whether to re-transmit the received data packet to another RFID tag of the plurality of RFID tags 102 (FIG. 1) or to the central unit 104 (FIG. 1) based on the set of logic stored in the memory 206 of the RFID tag 202. In one embodiment, the set of logic is permanently stored in the memory 206 of the RFID tags 202 and cannot be changed due to the fact the set of logic is burned into silicon comprising the RFID tag 202. However, in other embodiments, the set of logic is dynamically stored in volatile or non-volatile memory 206 of the RFID tags 202 and may be received from other devices such as the central unit 104 (FIG. 1).

In one embodiment, the RFID tags 202 may comprises a power source 210 for transmitting a data packet. However in other embodiments, the RFID tags 202 do not comprise a power source 210. In embodiments comprising a power source, the RFID tags 202 may periodically transmit a data packet, may continually transmit a data packet, or may only transmit a data packet in response to a trigger signal from the central unit 104 (FIG. 1) or some other device. In embodiments where the RFID tag 202 does not comprise a power source 210, the RFID tags 202 may only transmit a data packet in response to a trigger signal that provides power to the RFID tag 202 for transmitting the data packet. The RFID tags 202 may receive a trigger signal from the central unit 104 (FIG. 1) or any other type of device capable to sending a trigger signal to the RFID tags 202.

Referring again to FIG. 1, the central unit 104 may be a device equipped with a radio transmitter and receiver such as a RFID reader, or any other type of device capable of receiving data packets from the RFID tags 102. Typically, the central unit 104 is operative to transmit both data packets comprising a set of logic and trigger signals to at least one of the plurality of RFID tags 102, and to receive data packets from one or more of the plurality of RFID tags 102.

RFID tags 102 can typically transmit a data packet over a limited transmission range. Therefore, each of the plurality of RFID tags 102 are placed within the RFID mesh network 100 so that each RFID tag may transmit a data packet to at least one other RFID tag of the plurality of RFID tags 102 or the central unit 104. For example, a first RFID tag 106 of the plurality of RFID tags 102 may be operative to transmit a data packet within a transmission range r 108. As seen in FIG. 1, a second RFID tag 110 of the plurality if RFID tags 102 is located within the transmission range r 108 of the first RFID tag 106 so that the first RFID tag 106 may transmit a data packet to the second RFID tag 110. However, other RFID tags such as a third RFID tag 112 of the plurality of RFID tags 102 that are outside the transmission range r 108 of the first RFID tag 106 may not receive a data packet transmitted from the first RFID tag 106.

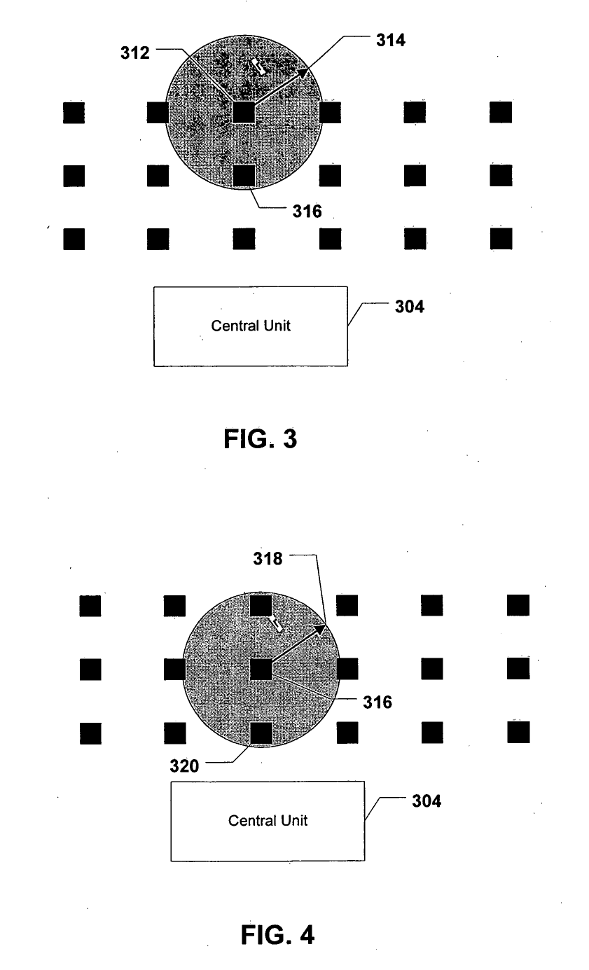

During operation, the plurality of RFID tags operate to relay data packets to the central unit 104 from RFID tags 102 that cannot transmit a data packet directly to the central unit 104. FIGS. 3, 4 and 5 show the propagation of a data packet to the central unit 304 from a RFID tag 312 that cannot transmit the data packet directly to the central unit 304.

FIG. 3 shows RFID tag 312 with a transmission range r 314 transmitting a data packet. RFID tags within the transmission range r 314, such as RFID tag 316, receive the data packet and determine whether to re-transmit the data packet based on a set of logic. Assuming RFID tag 316 determines to re-transmit the data packet received from RFID tag 312, the data packet is re-transmitted.

FIG. 4 shows RFID tag 316 with a transmission range r 318 transmitting the received data packet. RFID tags within the transmission range r 318, such as RFID tag 320, receive the data packet and determine whether to re-transmit the data packed based on a set of logic. Assuming RFID tag 320 determines to re-transmit the data packed received from RFID tag 316, the data packed is re-transmitted.

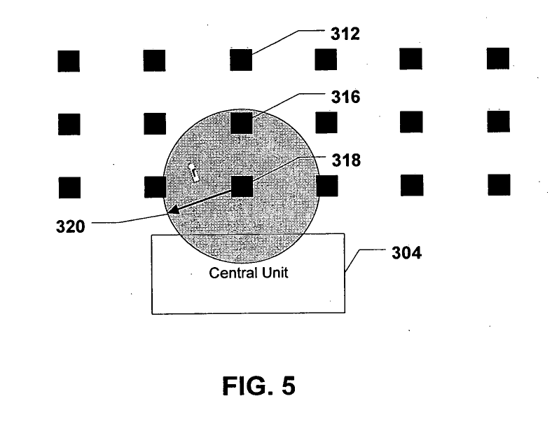

FIG. 5 shows RFID tag 320 with a transmission range r 322 transmitting the received data packet. Due to the fact the central unit 304 is within the transmission range r of RFID tag 320, the received data packet is transmitted to the central unit 304 and the detection is complete.

Referring again to FIG. 1, it will be appreciated that each time a RFID tag of the plurality of RFID tags 102 relays a data packet, the number of copies of the data packet within the network 100 multiplies due to the number of RFID tags 102 that may receive and re-transmit the data packet. Multiple copies of the data packet may create congestion within the network 100 leading to lost data packets caused by data packet collision and inaccurate detection of the plurality of RFID tags 102.

In order to reduce the number of packets being transmitted within the mesh RFID network 102, each RFID tag makes a random decision whether to re-transmit a received data packet according to the logic stored in the RFID tag. Even though the decision whether to re-transmit a received data packet is random, the probability that the receiving RFID tag will re-transmit (relay) the received data packet is defined to be a. As described below, the probability a may be altered to optimize the probability that the control unit 104 will receive at least one copy of each unique data packet transmitted for a RFID tag 102 while reducing congestion and data packet collision within the RFID mesh network sot that the RFID mesh network is bounded and stable. The RFID mesh network is defined to be bounded and stable when a network is free from congestion and data packed collisions caused by excessive traffic generated by each RFID tag attempting to relay multiple copies of one data packet.

To determine a probability a where the RFID mesh network is bounded and stable, a relationship between one iteration of re-transmission (n) and the next iteration of re-transmission (n+1) is calculated. All copies of a data packet are preferably located within a circle having a radius equal to the distance of the transmission range (r) each RFID tag may transmit a data packet multiplied by the number of iterations of re-transmission (n) that have taken place in the RFID mesh network.

If there are no collisions within the RFID mesh network, the relationship of the number of data packets during one iteration of re-transmission (Pn) and the number of data packets during a next iteration of re-transmission (Pₙ₊₁) can be expressed as:
Pₙ₊₁=dαPₙ,
where d is the number of RFID tags within a range equal to the area of the RFID mesh network having a radius of the transmission range (π*r²) divided by the density of nodes in the RFID mesh network, and a is the probability a RFID tag will re-transmit a received data packet. However, due to collisions of data packets within the network, as shown in more detail in the Appendix, the actual relationship between the number of data packets during one iteration of re-transmission (Pₙ) and the number of data packets during a next iteration of re-transmission (Pₙ₊₁) can be expressed as:

$${P}_{n + 1} = d α {P}_{n} [ 1 - ( {P}_{n} - 1 ) \frac{α}{{n}^{2}} ] ,$$

where d is the number of RFID tags within a range equal to the area of the RFID mesh network having a radius of the transmission range (π*r²) divided by the density of nodes in the RFID mesh network, a is the probability a RFID tag will re-transmit a received data packet, and n is the number of iterations of re-transmissions that have occurred.

Using the relationship between the number of packets during one iteration of re-transmission and the number of data packets during the next iteration of re-transmission with collisions as expressed above, a value for the probability a can be calculated such that the RFID mesh network is bounded and stable. In a detailed analysis shown in the Appendix below, the RFID mesh network is found to be bounded and stable as long as the probability a is less than or equal to the inverse of the number of RFID tags within a range equal to the area of the RFID mesh network having a radius of the transmission range (π*r²) divided by the density of nodes in the RFID mesh network (d⁻¹). In other words, the RFID mesh network is bounded and stable when:
α≦d⁻¹.

As shown in the Appendix, if N is the maximum distance that a RFID tag is located from a RFID tag that originally transmitted a data packet, the number of data packets during each iteration of re-transmission can be expressed as:

$${P}_{n + 1} {P}_{n} [ 1 - ( {P}_{n} - 1 ) \frac{α}{{\tilde{n}}^{2}} ]$$

$$( \tilde{n} = n for n \leq N , \tilde{n} = N otherwise ) .$$

Similarly, as shown in detail in the Appendix below, the probability of the central unit receiving a data packet may be expressed as:

$$\begin{matrix}{R}_{n + 1} = {P}_{n} \frac{α}{{\tilde{n}}^{2}} [ 1 - ( {P}_{n} - 1 ) \frac{α}{{\tilde{n}}^{2}} ] & n > N . \\ = 0 & otherwise\end{matrix}$$

Using the equation expressing the probability the central unit will receive a data packet and the limitation of α≦d⁻¹, α can be adjusted to ensure that a data packet is eventually transmitted to the central unit between 99% and 99.9% of the time. This ensures accurate detection of each of the plurality of RFID tags while prohibiting collision of data packets and inaccurate RFID tag detection.

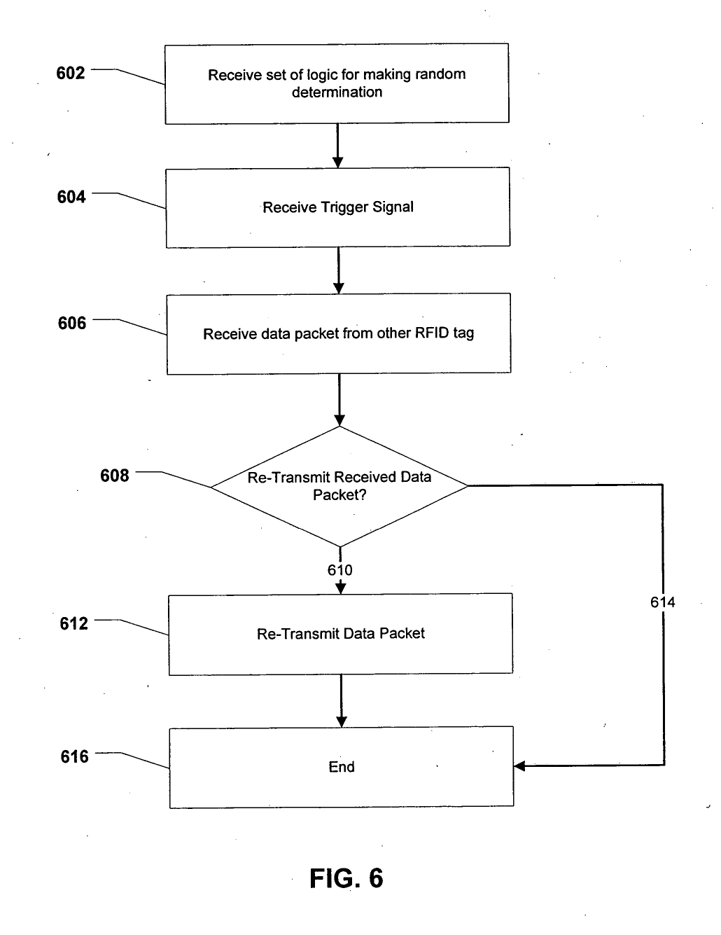

FIG. 6 shows a flow chart for operation of an RFID tag that is receiving a data packet and determining whether to re-transmit the data packet during an iteration of re-transmission. The method begins at step 602 with the RFID tag receiving a set of logic for making a random decision with a probability of α whether to re-transmit a data packet received from the other RFID tag. However as explained above, in other embodiments the set of logic may be permanently stored in the RFID tag and is not received from another source during operation.

The RFID tag receives a trigger signal at step 604 and a data packet from another RFID tag at step 606. In response to receiving the data packet, the RFID tag makes a random decision within a probability of a whether to re-transmit the received data packet based on the set of logic 608. If the RFID tag decides to re-transmit the data packet 610, the data packet is re-transmitted to at least one RFID tag or the central unit with the transmission range of the RFID tag 612. Alternatively, if the RFID tag decides not to re-transmit the data packet 614, the RFID tag does nothing for the current iteration 616.

Typically this process repeats a number of times to optimize the probability that data packets from RFID tags that cannot directly transmit to the central unit, are relayed by other RFID tags to the central unit. It should be noted that in alternative embodiments, the RFID tag will periodically transmit its own data packet or re-transmit data packets from other RFID tags independent of a trigger signal.

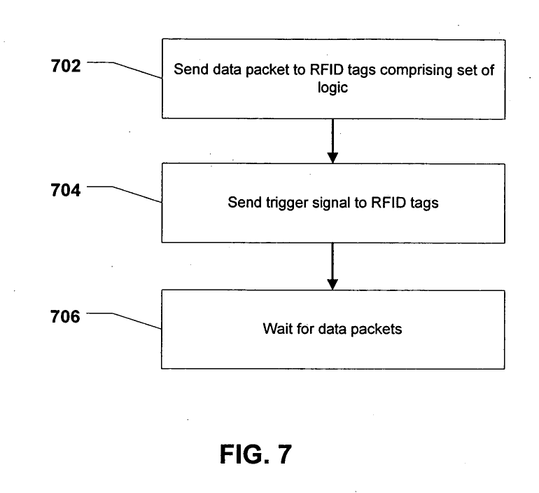

FIG. 7 shows a flow chart for operation of a central unit that is sending a data packet comprising a set of logic to the plurality RFID tags and receiving unique data packets form the RFID tags. The method begins at step 702 with the central unit sending a data packet to the plurality of RFID tags comprising a set of logic for an RFID tag to make a random determination, having a probability α, whether to re-transmit a data packet received from another RFID tag.

At step 704, the central unit sends a trigger signal to the plurality of RFID tags and waits for data packets from the RFID tags at step 706. Typically, the central unit will wait for data packets from the RFID tags a predetermined amount of time based on a timer.

Accordingly, the described preferred embodiments provide a method and system for efficiently controlling a RFID mesh network. A plurality of RFID tags is disclosed that are operative to transmit a unique data packet, and to receive and re-transmit unique data packets from other RFID tags. The plurality of RFID tags operate together to relay data packets to the central unit from RFID tags that cannot directly transmit a data packet to the central unit. Additionally, to alleviate congestion in the RFID mesh network, each RFID tag makes a random decision with a probability of α whether to re-transmit a received data packet. The probability α is adjusted for the RFID mesh network so that the network is bounded and stable, and there is a high probability that at least one copy of all unique data packets will be received at the central unit.

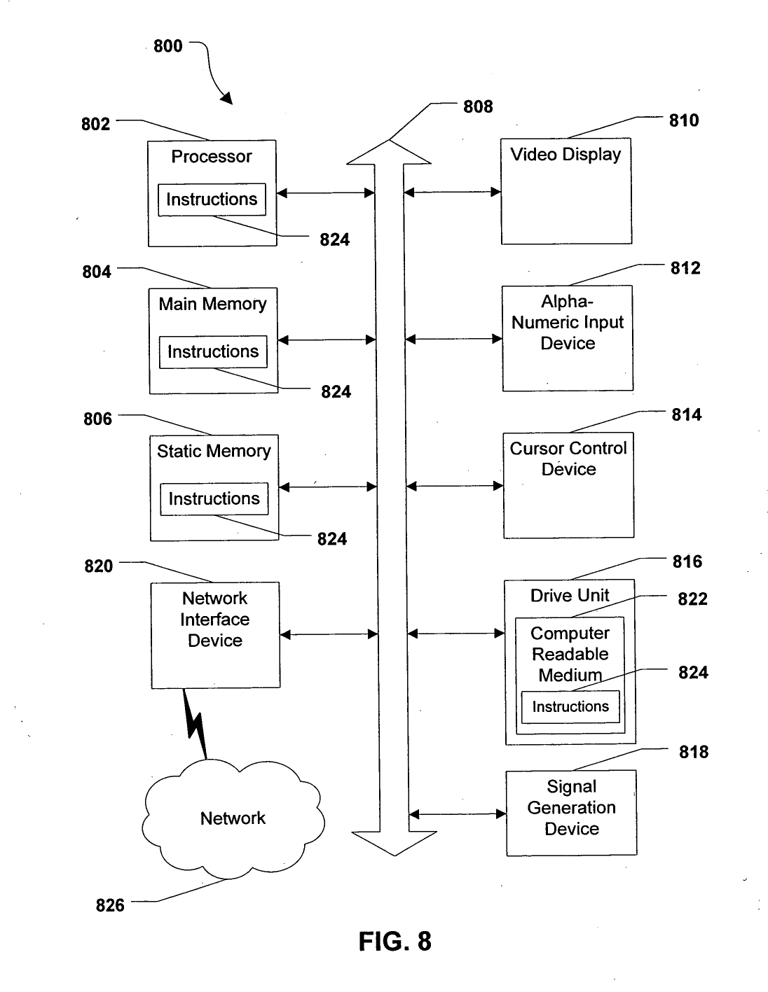

Referring to FIG. 8, an illustrative embodiment of a general computer system is shown and is designated 800. The computer system 800 can include a set of instructions that can be executed to cause the computer system 800 to perform any one or more of the methods or computer based functions disclosed herein. The computer system 800 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics processing unit (GPU), or both. Moreover, the computer system 800 can include a main memory 804 and a static memory 806 that can communicate with each other via a bus 808. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard, and a cursor control device 814, such as a mouse. The computer system 800 can also include a disk drive unit 816, a signal generation device 818, such as a speaker or remote control, and a network interface device 820.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives and executes instructions 824 responsive to a propagated signal, so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

### APPENDIX

The following appendix describes in detail the equations necessary to calculate a probability a that a RFID network will re-transmit a received data packet such that the RFID mesh network is bounded and stable, as well as the equations necessary to optimize the probability a central unit will receive a copy of each unique data packet of a RFID tag.

Assuming that an RFID tag is able to transmit a data packet to all other RFID tags within a transmission range r from the RFID tag without collision, the relationship of the number of data packets during one iteration of re-transmission (Pₙ) and the number of data packets during a next iteration of re-transmission (Pₙ₊₁) can be expressed as:
Pₙ₊₁=dαPₙ,
where d is the number of RFID tags within a range equal to the area of the RFID mesh network having a radius of the transmission range (π*r²) divided by the density of nodes in the RFID mesh network and a is the probability of whether a RFID tag will re-transmit a data packet received from another RFID tag.

However, there are often collisions of data packets within the RFID mesh network during successive iterations. A data packet collision occurs when two or more data packets arrive at a single RFID tag at one time and a data packet survival occurs when only one data packet arrives at a single RFID tag at one time. Therefore, the probability of collision is defined as the probability of two or more data packet transmissions reaching a single RFID tag at one time and the probability of survival is defined as the probability that two or more data packet transmissions will not reach a single RFID tag at one time. It will be appreciated that the probability of survival is the complement of the probability of collision.

The collision and survival probability of a first RFID tag in the plurality of RFID tags at a distance R from the RFID tag originally transmitting a data packet during a (n+1)^{th} iteration of re-transmission is described. By definition, the distance (R) from the RFID tag originally transmitting the data packet should be smaller than a distance equal to the number of iteration of re-transmission (n+1) multiplied by the transmission range (r) of each RFID tag due to the fact (n+1)*r is the maximum distance a copy of the data packet could have traveled after the (n+1)^{th} iteration of re-transmission.

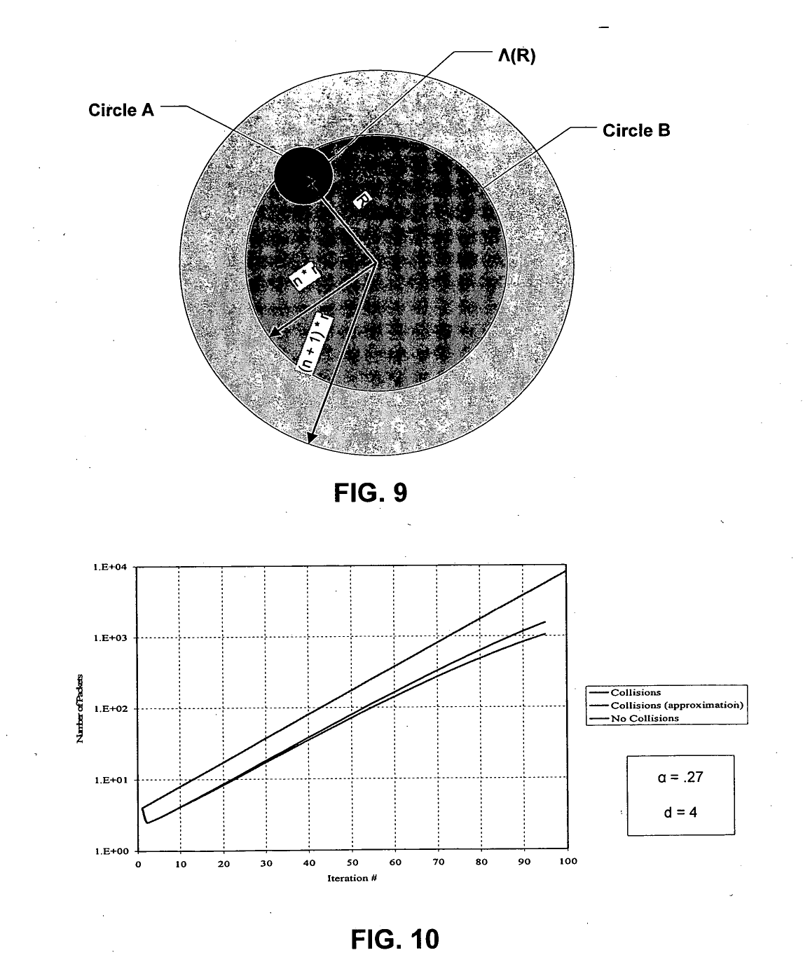

FIG. 9 is a graph illustrating transmission range during successive iterations of re-transmission of a data packet and an area associated with each transmission range. Due to the fact the transmission range of each RFID tag is r, all RFID tags transmitting data packets to the receiving RFID tag must be located within a circle of radius r (Circle A in FIG. 7). The area of the circle of radius r representing the area from which a data packet may be received that overlaps a circle of radius n*r (Circle B in FIG. 7) representing the area in which all copies of a data packet should be located after n iterations of re-transmission, may be expressed as:
πr²*λ(R),
where λ(R) is a fraction of the area of the circle having a radius r (Circle A) that overlaps with the circle of radius n*r (Circle B).

The distance (R) a copy of the data packet is from the RFID tag originally transmitting the data packet should be less than the distance equal to (n+1)*r. It will be appreciated that as the distance (R) the copy of the data packet is from the RFID tag originally transmitting the data packet approaches a value equal to (n+1)*r, the fraction λ(R) approaches zero corresponding to no portion of the circle having a radius of r overlapping the circle of radius n*r. Therefore, assuming all the copies of the data packet during the current iteration of re-transmission (Pₙ) are uniformly distributed within a circle of radius equal to the number of iterations of re-transmission (n) multiplied by the transmission range of the RFID tags (r), the probability that that a number of data packets (k) of the copies of data packets (Pₙ) within the range of the first RFID tag may be expressed by the binomial distribution:

$$Pr \{ n = k \text{\vert} R \} = {{\frac{{P}_{n} !}{k ! ( {P}_{n} - k ) !} [ \frac{λ ( R )}{{n}^{2}} ]}^{k} [ 1 - \frac{λ ( R )}{{n}^{2}} ]}^{{P}_{n} - k} .$$

However, due to the fact on average, each RFID tag will transmit each copy of the data packet with a probability α, the probability of a number of copies (k) of all of the copies of the data packet (Pₙ) reaching the first RFID tag may be calculated by the binomial distribution:

$$Pr \{ k \text{\vert} R \} = {{\frac{{P}_{n} !}{k ! ( {P}_{n} - k ) !} [ \frac{α λ ( R )}{{n}^{2}} ]}^{k} [ 1 - \frac{α λ ( R )}{{n}^{2}} ]}^{{P}_{n} - k} .$$

Accordingly, the collision probability can be expressed using the equation:

$$\begin{matrix}{C}_{n} ( R ) = \frac{Pr \{ k \geq 2 \}}{Pr \{ k \geq 1 \}} \\ = \frac{1 - {[ 1 - \frac{α λ ( R )}{{n}^{2}} ]}^{{P}_{n}} - {P}_{n} {\frac{α λ ( R )}{{n}^{2}} [ 1 - \frac{α λ ( R )}{{n}^{2}} ]}^{{P}_{n} - 1}}{1 - {[ 1 - \frac{α λ ( R )}{{n}^{2}} ]}^{{P}_{n}}} .\end{matrix}$$

Thus, the survival probability during the (n+1)^{th} iteration of re-transmission of a data packet at a distance R from the RFID tag originally transmitting the data packet is the compliment of the collision probability, given by:

$$\begin{matrix}{S}_{n} ( R ) = \frac{Pr \{ k \geq 2 \}}{Pr \{ k \geq 1 \}} \\ = \frac{{P}_{n} {\frac{α λ ( R )}{{n}^{2}} [ 1 - \frac{α λ ( R )}{{n}^{2}} ]}^{{P}_{n} - 1}}{1 - {[ 1 - \frac{α λ ( R )}{{n}^{2}} ]}^{{P}_{n}}} .\end{matrix}$$

For a large number of iterations of re-transmissions,

$$\frac{α λ ( R )}{{n}^{2}} 1 ,$$

such that an approximation of the survival probability is equal to:

$${S}_{n} ( R ) = 1 - ( {P}_{n} - 1 ) \frac{α λ ( R )}{{n}^{2}} .$$

An average probability of survival over the iterations of re-transmission may be determined by integrating the position dependant survival probability above over the entire circle of radius equal to (n+1)*r according to the equation:

$${\hat{S}}_{n} = \frac{1}{{π ( n + 1 )}^{2} {r}^{2}} {\int }_{0}^{2 π} {\int }_{0}^{( n + 1 ) r} [ 1 - ( {P}_{n} - 1 ) \frac{α λ ( R )}{{n}^{2}} ] r ⅆ r ⅆ θ \frac{2}{{( n + 1 )}^{2} {r}^{2}} {\int }_{0}^{( n + 1 ) r} [ 1 - ( {P}_{n} - 1 ) \frac{α λ ( R )}{{n}^{2}} ] r ⅆ r .$$

Assuming the expression for λ(R) can be approximated as 1 for a large number of iterations of re-transmissions (n), the average number of surviving data packets after n+1 iterations of re-transmissions can be calculated as:

$${P}_{n + 1} = d α {P}_{n} [ 1 - ( {P}_{n} - 1 ) \frac{α}{{n}^{2}} ] .$$

λ(R) is less than 1 only when (n+1)*r ≧R ≧(n−1)*r. Otherwise, λ(R) is equal to one. As the number of iterations n increases, the fraction of the area where λ(R) is less than one decreases. For a large number of iterations n, we can simply approximate that λ(R) is equal to one everywhere.

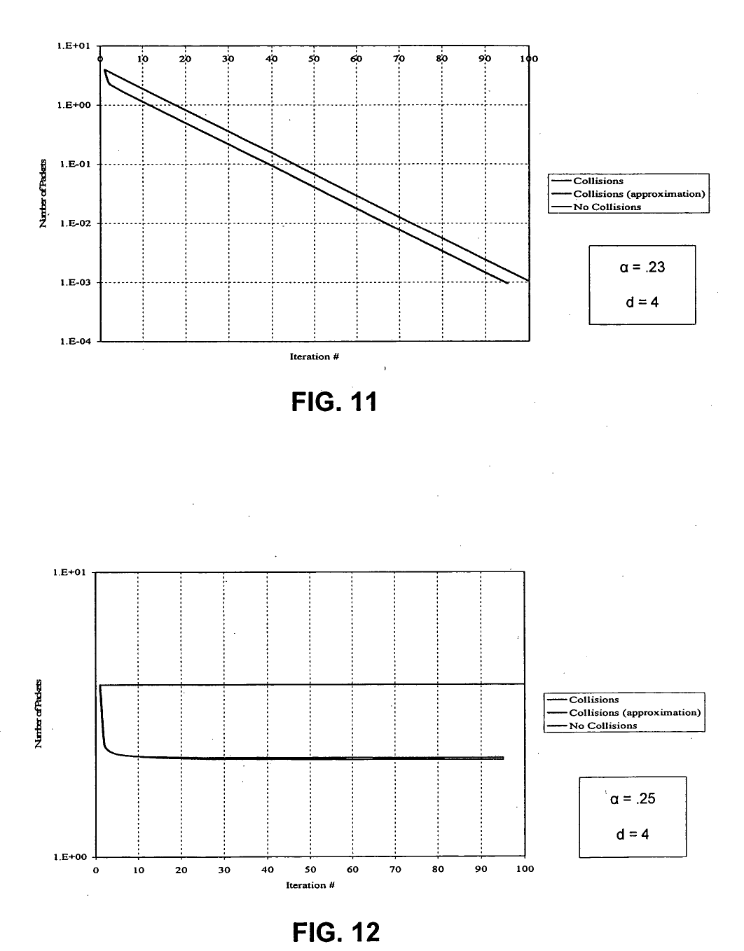

FIGS. 10-12 each illustrate the number of surviving data packets after iterations of re-transmission for three different models of data packet collision. A first line shows the number of data packets after iterations of re-transmission with no collisions. A second line shows the number of surviving packets after each iteration of re-transmission where the collision probability is calculated based on the equation:

$${S}_{n} ( R ) = \frac{Pr \{ k \geq 2 \}}{Pr \{ k \geq 1 \}} = \frac{{P}_{n} {\frac{αλ ( R )}{{n}^{2}} [ 1 - \frac{αλ ( R )}{{n}^{2}} ]}^{{P}_{n} - 1}}{1 - {[ 1 - \frac{αλ ( R )}{{n}^{2}} ]}^{{P}_{n}}} .$$

Finally, a third line shows the number of surviving packets after each iteration of re-transmission where the collision probability is calculated based on the equation:

$${P}_{n + 1} = d α {P}_{n} [ 1 - ( {P}_{n} - 1 ) \frac{α}{{n}^{2}} ] .$$

As seen in FIGS. 10-12, the sequence Pn is non-divergent as long as α≦d⁻¹. A more detailed analysis of the stability of the nonlinear difference equation as given is beyond the scope of the present disclosure. Therefore, for the purpose of the discussion within the Appendix, the value of α*d is set to one (1) due to the fact this is the most optimal operating point. Thus, the nonlinear difference equation relating the number of packets in one iteration of re-transmission (Pₙ) and the number of packets in the next iteration of re-transmission (Pₙ₊₁) is given by the equation:

$${P}_{n + 1} = {P}_{n} [ 1 - ( {P}_{n} - 1 ) \frac{α}{ {n}^{2}} ] .$$

Using the above equation, the probability that a central unit is located a distance of m*r from the RFID tag originally transmitting the data packet during the (n+1)^{th} iteration is given by the equation:

$$\begin{matrix}{R}_{ n + 1} = {P}_{n} {\frac{α}{{n}^{2}} [ 1 - \frac{α}{{n}^{2}} ]}^{{P}_{n} - 1} \approx \begin{matrix}{P}_{n} \frac{α}{{n}^{2}} [ 1 - ( {P}_{n} - 1 ) \frac{α}{{n}^{2}} ] & n > m\end{matrix} \\ = \begin{matrix}0 & otherwise .\end{matrix}\end{matrix}$$

Thus, the probability that the central unit gets the packet at least once is given by:

$$\tilde{R} = 1 - {\prod }_{n = 1}^{∞} ( 1 - {R}_{n} )$$

1. A RFID network comprising:
a plurality of RFID tags, each of the plurality of RFID tags operative to transmit a data packet comprising a unique identification for that RFID tag, receive a data packet from another RFID tag of the plurality of RFID tags, make a random determination based on a probability whether to re-transmit the received data packet, and re-transmit the received data packet dependent on the random determination; and
a central unit in communication with the plurality of RFID tags to receive data packets from the plurality of RFID tags.

2. The RFID network of claim 1, wherein at least one of the plurality of RFID tags comprises a power source.

3. The RFID network of claim 2, wherein the at least one of the plurality of RFID tags continuously transmit the data packet and re-transmit received data packets based on the random determination.

4. The RFID network of claim 2, wherein at least one of the plurality of RFID tags periodically transmit the data packet and re-transmit received data packets based on the random determination.

5. The RFID network of claim 1, wherein a set of logic to make the random determination whether to re-transmit the received data packet is permanently stored in at least one of the plurality of RFID tags.

6. The RFID network of claim 5, wherein the at least one of the plurality of RFID tags comprises silicon and the set of logic set of logic stored in the at least one of the plurality of RFID tags is burned in the silicon of the at least one of the plurality of RFID tags.

7. The RFID network of claim 1, wherein a set of logic to make the random determination whether to re-transmit the received data packet is dynamically stored in at least one of the plurality of RFID tags.

8. The RFID network of claim 7, wherein the set of logic is stored in a volatile memory of the at least one of the plurality of RFID tags.

9. The RFID network of claim 7, wherein the set of logic is stored in a non-volatile memory of the at least one of the plurality of RFID tags.

10. The RFID network of claim 7, wherein the central unit sends the set of logic to make the random determination to the plurality of RFID tags.

11. The RFID network of claim 1, wherein the central unit is further operative to send a trigger signal to the plurality of RFID tags and the plurality of RFID tags is further operative to transmit the data packet, to make the random determination based on the probability whether to re-transmit the received data packet and re-transmit the received data packet dependent on the random determination in response to receiving the trigger signal from the central unit.

12. A RFID tag in communication with at least one other RFID tag, the RFID tag operative to transmit a data packet comprising a unique identification for the RFID tag, receive a data packet from the at least one other RFID tag, make a random determination based on a probability whether to re-transmit the received data packet, and re-transmit the received data packet dependent on the random determination.

13. A method for operating a RFID tag in communication with a plurality of other RFID tags, the method comprising:
receiving a data packet from the at least one other RFID tag, wherein the data packet comprises a unique identification for one of the plurality of RFID tags;
using a set of logic to make a random determination, based on a probability, whether to re-transmit the received data packet; and
re-transmitting the received communication dependent on the random determination.

14. The method of claim 13, further comprising:
transmitting a data packet comprising a unique identification for the RFID tag.

15. The method of claim 13, further comprising:
receiving a data packet comprising the set of logic from a central unit; and
storing the set of logic in a memory of the RFID tag.

16. The method of claim 13 wherein the received data packet is re-transmitted to a central unit.

17. A method of operating a central unit in communication with at least one RFID tag, the method comprising:
sending a set of logic to the at least one RFID tag, the set of logic for an RFID tag to make a random determination, based on a probability, whether to re-transmit a received data packet received from another RFID tag;
sending a trigger signal to the at least one RFID tag requesting a data packet at least from the at least one RFID tag, wherein the data packet comprises a unique identification for at least one RFID tag; and
receiving at least one data packet from the at least one RFID tag.

18. A computer-readable storage medium comprising a set of instructions for operating a central unit in communication with at least one RFID tag, the set of instructions to direct a computer system to perform acts of:
sending a set of logic to the at least one RFID tag, the set of logic for an RFID tag to make a random determination, based on a probability, whether to re-transmit a received data packet received from another RFID tag;
sending a trigger signal to the at least one RFID tag requesting a data packet at least from the at least one RFID tag, wherein the data packet comprises a unique identification for at least one RFID tag; and
receiving at least one data packet from the at least one RFID tag.
